(19) United States
(12) Patent Application Publication
(10) Pub. No.: US 2006/0120487 A1
(43) Pub. Date: Jun. 8, 2006

(54) Frequency offset estimating method and frequency offset correcting apparatus utilizing said method

(76) Inventors: Seigo Nakao, Gifu-shi (JP); Yasuhiro Tanaka, Ichinomiya (JP)

Correspondence Address: MCDERMOTT WILL & EMERY LLP, 600 13TH STREET, N.W., WASHINGTON, DC, 20005-3096, US

(21) Appl. No.: 11/295,727

(22) Filed: Dec. 7, 2005

(30) Foreign Application Priority Data
Dec. 7, 2004 (JP) 2004-353898

(51) Int. Cl. H04L 27/14

(52) U.S. Cl. 375/334

(57) ABSTRACT

A frequency offset correcting unit estimates an initial frequency offset and corrects the estimated initial frequency offset. Then the frequency offset correction unit also corrects frequency offsets by incorporating residual components of the frequency offsets. A receiving weight vector computing unit computes receiving weight vector signals by use of LMS algorithm. Then the receiving weight vector computing unit estimates residual components of frequency offset contained in pilot signals by applying LMS algorithm to the pilot signals. Multipliers weight frequency-domain signals with the receiving weight vector signals, and an adder sums up the output of the multipliers so as to output a combined signal.

### BACKGROUND OF THE INVENTION

1. Field of the Invention

The present invention relates to the frequency offset estimating techniques, and it particularly relates to a frequency offset estimating method for estimating frequency offsets contained in signals received by a plurality of antennas and also particularly relates to a frequency offset correcting apparatus utilizing said method.

2. Description of the Related Art

In wireless communication, it is generally desired that the limited frequency resources be used effectively. One of the technologies that effectively utilize the frequency resources is adaptive array antenna technology. In the adaptive array antenna technology, the amplitude and phase of signals to be processed in a plurality of antennas are so controlled as to form a predetermined directional pattern of the antenna. More specifically, the apparatus provided with adaptive array antennas changes respectively the amplitude and phase of signals received by a plurality of antennas and sums up a plurality of the thus changed received signals. As a result, the apparatus receives the signals equivalent to the signals received by the antenna having the directional pattern corresponding to the variation in said amplitude and phase (hereinafter referred to as “weight”). Then, the signals are transmitted in the directional pattern of the antenna corresponding to the weight.

In the adaptive array antenna technique, a processing for calculating weights includes one based on the minimum mean square error (MMSE) method. As an MMSE method, adaptive algorithms, such as RLS (Recursive Least Squares) algorithm and LMS (Least Mean Squares) algorithm, are used. In general, on the other hand, the frequency offset is present between carriers outputted from a local oscillator in a transmitting apparatus and carriers outputted from a local oscillator in a receiving apparatus. As a result thereof, the phase error is caused. For example, if a phase modulation such as QPSK (Quadrature Phase Shift Keying) is used as a modulation scheme between the transmitting apparatus and the receiving apparatus, the constellation of received signals is rotated due to the phase error. This rotation of constellation generally degrades the transmission quality of signals. There are some cases where the frequency offset can be estimated by an adaptive algorithm in the adaptive array antenna technique (See Reference (1) in the following Related Art List, for instance)

### RELATED ART LIST

(1) Japanese Patent Application Laid-Open No. Hei 10-210099.

When the weights are to be calculated by using LMS algorithm as the adaptive algorithm, the frequency offsets can also be calculated in a form such that the frequency offsets are contained in the weights. However, the range in which the frequency offset can be calculated will be narrow in general. Hence, the larger the frequency offset becomes, the harder the accurate estimation of said frequency offset will be. In addition, if the number of antennas increases, the number of weights to which the LMS algorithm is to be applied also increases. Thus, the range in which the frequency offset can be calculated will tend to be further narrowed. As one method, on the other hand, for broadening the range in which the frequency offset can be estimated using LMS algorithm, the method may be such that the step-size parameter of LMS algorithm is made larger. However, according to this method, the filtering effect is small in general, thus resulting in the drop of signal transmission quality.

### SUMMARY OF THE INVENTION

The present invention has been made in view of the foregoing circumstances and an objective thereof is to provide a method for estimating frequency offset to correct frequency offset contained among signals received by a plurality of antennas and to provide a frequency-offset correcting apparatus utilizing said method.

In order to solve the above problems, a frequency offset correcting apparatus according to a preferred embodiment of the present invention, comprises: an input unit which inputs a plurality of received signals, corresponding respectively to a plurality of antennas, that contain known signals; a correction unit which corrects respectively frequency offsets contained in the plurality of received signals; a processing unit which derives weight vectors corresponding to the known signals and error between the weight vectors and the known signals, respectively, by applying an adaptive algorithm to a plurality of corrected received signals; and an estimation unit which estimates residual components of the frequency offsets contained in the plurality of corrected received signals and those of frequency offsets corresponding to the known signals, based on the derived weight vectors and the derived error. The correction unit corrects the frequency offsets by reflecting the estimated residual components of frequency offsets.

According to this embodiment, the weighting factors and error derived in an adaptive algorithm are used for the estimation of the residual components of frequency offsets. Hence, the estimation processing for residual components and part of the adaptive algorithm can be put to a common use. As a result, the frequency offset can be corrected while preventing the increase in circuit scale.

As the residual components of frequency offsets the estimation unit may multiply complex conjugation of the plurality of corrected received signals respectively by the derived error and may extract imaginary components from a division result where the multiplication result is divided by the derived weight vectors. In this case, the residual component of frequency offset can be estimated using a simplified processing.

The processing may derive weight vectors corresponding to signals other than the known signals, and the apparatus may further comprise a weighting unit which weights the plurality of corrected received signals, respectively, with the weight vectors derived by the processing unit. In this case, the weighting is done by weight vectors, so that the transmission quality can be improved.

The frequency offset correcting apparatus may further comprise a frequency-domain conversion unit which converts the plurality of corrected received signals, respectively, into frequency domains and outputs a plurality of frequency-domain signals to each corrected received signal. The processing unit may extract known signal components contained in the plurality of frequency-domain signals and may derive the weight vectors and error by applying adaptive algorithm to mutually corresponding known signals. The estimation unit may estimate the residual components of frequency offset corresponding to the known signals, based on the thus derived weight vectors and error. In this case, the apparatus according to the present embodiment can be applied to multicarrier signals.

The processing unit may extract a plurality of known signals contained in the plurality of frequency-domain signals and may derive weight vectors and error corresponding respectively to the plurality of known signals, whereas the estimation unit may estimate frequency offsets corresponding respectively to the plurality of known signals and may derive residual components of frequency offsets to be used by the correction unit, from the estimated frequency offsets corresponding respectively to the plurality of known signals. In this case, the residual components of frequency offsets corresponding respectively to a plurality of known signals are used so as to derive the residual components of frequency offsets to be used for correction, thus improving the derivation accuracy.

Another preferred embodiment according to the present invention relates to a method for estimating frequency offset. This method is characterized in that weight vectors corresponding to known signals and error between the weight vectors and the known signals are derived, respectively, by applying an adaptive algorithm to a plurality of received signals, corresponding respectively to a plurality of antennas, that contain the known signals, and residual components of the frequency offsets contained in a plurality of corrected received signals and those of frequency offsets corresponding to the known signals are estimated based on the derived weight vectors and error.

Still another preferred embodiment according to the present invention relates also to a method for estimating frequency offset. This method comprises: inputting a plurality of received signals, corresponding respectively to a plurality of antennas, that contain known signals; correcting respectively frequency offsets contained in the plurality of received signals; deriving weight vectors corresponding to the known signals and error between the weight vectors and the known signals, respectively, by applying an adaptive algorithm to a plurality of corrected received signals; and estimating residual components of the frequency offsets contained in the plurality of corrected received signals and those of frequency offsets corresponding to the known signals, based on the derived weight vectors and the derived error. The correcting may be such that the frequency offsets are corrected by reflecting the estimated residual components of frequency offsets.

The estimating may be such that, as the residual components of frequency offsets, complex conjugation of the plurality of corrected received signals are multiplied respectively by the derived error and then imaginary components are extracted from a division result where the multiplication result is divided by the derived weight vectors. The deriving may be such that weight vectors corresponding to signals other than the known signals are derived, the method further comprising weighting the plurality of corrected received signals, respectively, with the weight vectors derived by the deriving.

The method may further comprise converting the plurality of corrected received signals, respectively, into frequency domains and outputting a plurality of frequency-domain signals to each corrected received signal. The deriving may be such that known signal components contained in the plurality of frequency-domain signals are extracted and the weight vectors and error are derived by applying adaptive algorithm to mutually corresponding known signals, and the estimating may be such that the residual components of frequency offset corresponding to the known signals are estimated based on the thus derived weight vectors and error.

The deriving may be such that a plurality of known signals contained in the plurality of frequency-domain signals are extracted and weight vectors and error corresponding respectively to the plurality of known signals are derived, and the estimating may be such that frequency offsets corresponding respectively to the plurality of known signals are estimated and residual components of frequency offsets to be used in the correcting unit are derived from the estimated frequency offsets corresponding respectively to the plurality of known signals. The estimating may be such that residual components of frequency offsets in a period during which the plurality of corrected received signals are to be converted to the frequency domain are estimated. The deriving may be such that weight vectors corresponding to signals other than the known signals are derived, and the method may further comprise weighting the plurality of frequency-domain signals, respectively, with the weight vectors derived by the deriving.

Data may be composed of a plurality of streams. A known signal may be composed of a plurality of streams. A control signal may be composed of a plurality of streams.

It is to be noted that any arbitrary combination of the above-described structural components and expressions changed among a method, an apparatus, a system, a recording medium, a computer program and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 illustrates a spectrum of a multicarrier signal according to an embodiment of the present invention.

FIG. 2 illustrates a structure of a communication system according to an embodiment of the present invention.

FIG. 3 illustrates a structure of a burst format according to an embodiment of the present invention.

FIG. 4 illustrates a structure of a first radio unit shown in FIG. 1.

FIG. 5 illustrates a structure of a signal processing unit shown in FIG. 1.

FIG. 6 illustrates a structure of first frequency-domain signal shown in FIG. 5.

FIG. 7 illustrates a structure of a frequency offset correcting unit shown in FIG. 5.

FIG. 8 illustrates a structure of a receiving weight vector computing unit shown in FIG. 5.

FIG. 9 is a flowchart showing a procedure for correcting a frequency offset of FIG. 5.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

Before describing the present invention in detail, an outline of the present invention will be described first. Embodiments according to the present invention relates to a base station apparatus that performs adaptive array signal processing on a plurality of signals received by a plurality of antennas, respectively. Here, the received signals are those modulated, in particular, by the orthogonal frequency division multiplexing (OFDM), and they form burst signals. The base station apparatus converts a plurality of received signals into a plurality of baseband signals. The plurality of converted baseband signals contain frequency offsets, respectively.

The base station apparatus according to the present embodiment estimates coarsely or loosely the frequency offsets contained in the baseband signals, in a preamble in a leading portion thereof among burst signals, and corrects the estimated frequency offsets by feedforwad. After converting them into frequency-domain signals by FFT (Fast Fourier Transform), adaptive array signal processing is performed thereon. After a preamble period terminates, the base station apparatus estimates residual components contained in the estimated offsets and then corrects the thus estimated residual frequency offsets by subjecting them to a feedback.

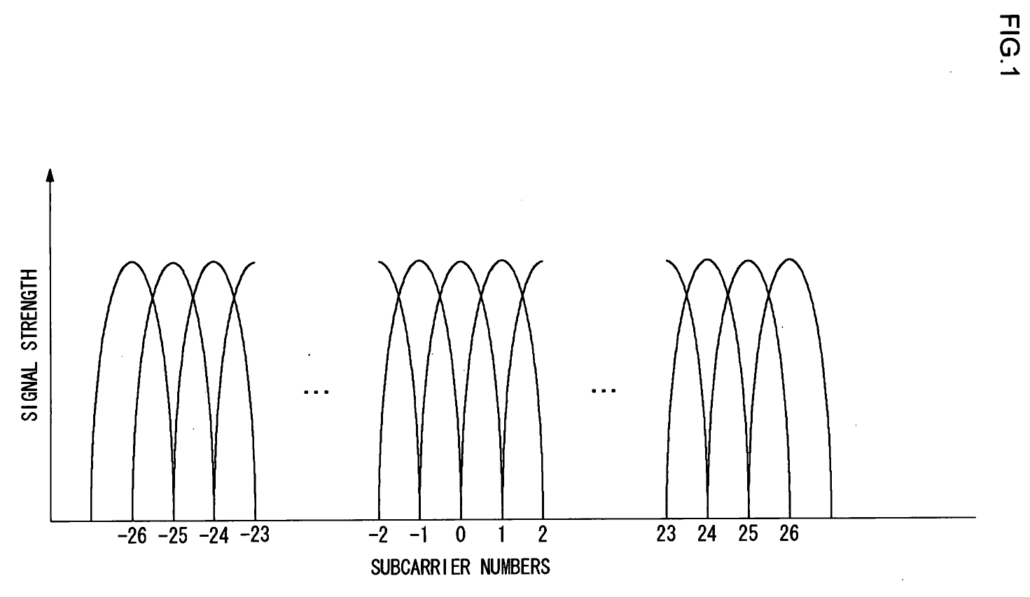

FIG. 1 illustrates a spectrum of a multicarrier signal according to an embodiment of the present invention. In particular, FIG. 1 shows a spectrum of multicarrier signal compatible with the OFDM modulation scheme. One of multicarriers in the OFDM modulation scheme is generally called a subcarrier. Herein, however, a subcarrier is designated by a “subcarrier number”. Similar to the IEEE802.11a standard, 53 subcarriers, namely, “−26” to “26“are defined here. It is to be noted that the subcarrier number “0” is set to null so as to reduce the effect of a direct current component in a baseband signal. Each subcarrier is modulated by a modulation scheme which is set variably. Used here is any of modulation schemes among BPSK (Binary Phase-Shift Keying), QPSK (Quadrature Phase-Shift Keying), 16QAM (Quadrature Amplitude Modulation) and 64QAM.

If frequency offset exists in a received multicarrier signal, the phase of the subcarrier signal will be rotated. This will now be explained. A signal transmitted from a transmitting apparatus is expressed by the following Equation (1)
S=A(A₁ exp(jω₁t)+A₂ exp(jω₂t)+A₃ exp(hω₃t)Λ+Aₙ exp(jωₙt)) (1)
where A₁ to Aₙ are each a vector that indicates a signal component contained in each subcarrier. If frequency offset is added to a multicarrier signal, then a received signal is expressed by:
S exp(jωt)=(A₁ exp(jω₁t)+A₂ exp(jω₂t)+Λ+Aₙ exp(jωₙt))exp(jωt) (2)

When the frequency offset is small, exp(jωt) can be approximated to a constant C and the signal in Equation (2) can be expressed by:
SC=(A₁ exp(jω₁t)+A₂ exp(jω₂t)+Λ+Aₙ exp(jωₙt))C (3)

When this signal is subjected to FFT, each subcarrier is expressed as CA₁, CA₂ or the like. This is equivalent to the fact that each subcarrier signal is rotated by a phase corresponding to its frequency offset.

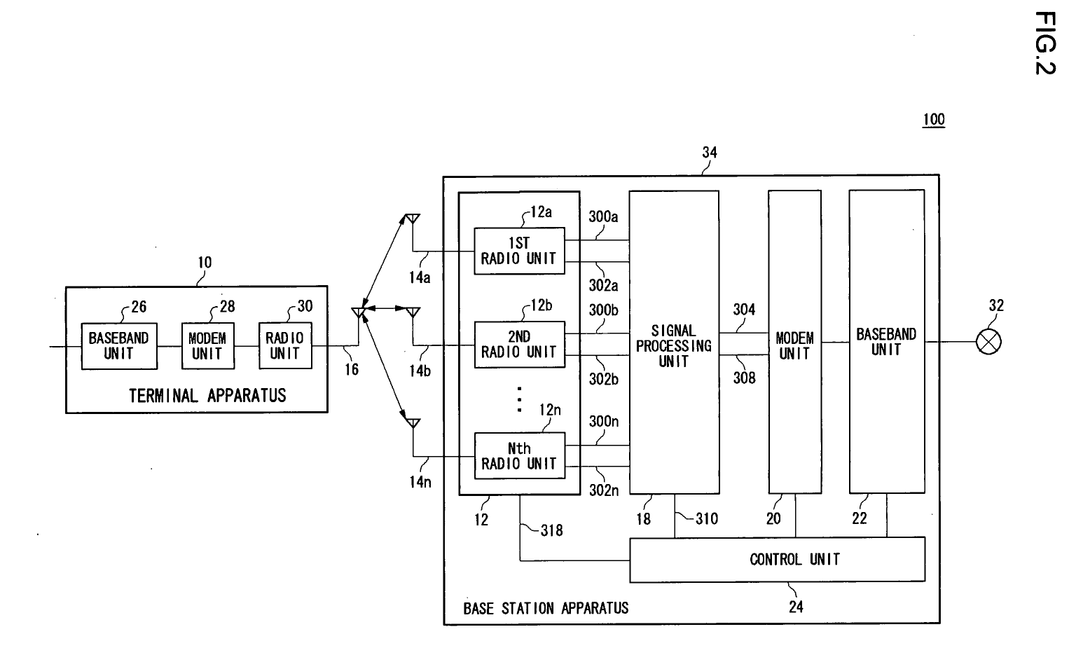

FIG. 2 illustrates a structure of a communication system 100 according to an embodiment of the present invention. The communication system 100 includes a terminal apparatus 10, a base station apparatus 34 and a network 32. The terminal apparatus 10 includes a baseband unit 26, a modem unit 28, a radio unit 30 and an antenna 16 for use with terminal apparatus. The base station apparatus 34 includes a first basestation antenna 14a, a second basestation antenna 14b, . . . and an Nth basestation antenna 14n, which are generically called “antenna 14 for use with base station apparatus” or “basestation antenna 14”, a first radio unit 12a, a second radio unit 12b, . . . and an Nth radio unit 12n, which are generically called “radio unit 12”, a signal processing unit 18, a modem unit 20, a baseband unit 22 and a control unit 24. The base station apparatus 34 includes as signals a first digital received signal 300a, a second digital received signal 300b, . . . and an Nth digital received signal 300n, which are generically called “digital received signal 300”, a first digital transmitted signal 302a, a second digital transmitted signal 302b, . . . and an Nth digital transmitted signal 302n, which are generically called “digital transmitted signal 302”, a synthesized signal 304, a pre-separation signal 308, a signal processor control signal 310 and a radio-unit control signal 318.

The baseband unit 22 in the base station apparatus 34 is an interface with the network 32. The baseband unit 26 in the terminal apparatus 10 is an interface with a PC connected to a terminal apparatus 10 or with an application inside the terminal apparatus 10. The baseband units 22 and 26 perform their respective upper-layer processings on signals to be transmitted from and received by the communication system 100. The baseband units 22 and 26 may also carry out error correction or automatic retransmission processing, but the description of such processings is omitted here.

The modem unit 20 in the base station apparatus 34 and the modem unit 28 in the terminal apparatus 10 perform modulation processing and demodulation processing. As a modulation scheme, the modem unit 20 and the modem unit 28 perform any of modulation schemes among BPSK, QPSK, 16QAM and 64QAM. An instruction on which modulation scheme is to be employed is received from the control unit 24. The modem units 20 and 28 perform IFFT in the modulation processing in response to the OFDM modulation scheme and performs FFT in the demodulation processing.

The signal processing unit 18 performs adaptive array signal processing. The details of adaptive array signal processing will be described later. The radio unit 12 in the base station apparatus 34 and the radio unit 30 in the terminal apparatus 10 carry out frequency conversion processing between baseband signals and radiofrequency signals. Here, the baseband signals are used by the signal processing unit 18, the modem unit 20, the baseband unit 22, the baseband unit 26 and the modem unit 28. The radio unit 12 and the radio unit 30 further perform amplification processing, A-D or D-A conversion processing and the like.

The basestation antennas 14 in the base station apparatus 34 and the terminal antenna 16 in the terminal apparatus 10 perform transmission/receiving processings on radiofrequency signals. The directivity of the respective antennas may be arbitrary and the number of basestation antennas 14 is denoted by N. The control unit 24 controls timings and the like for the radio unit 12, the signal processing unit 18, the modem unit 20 and the baseband unit 22.

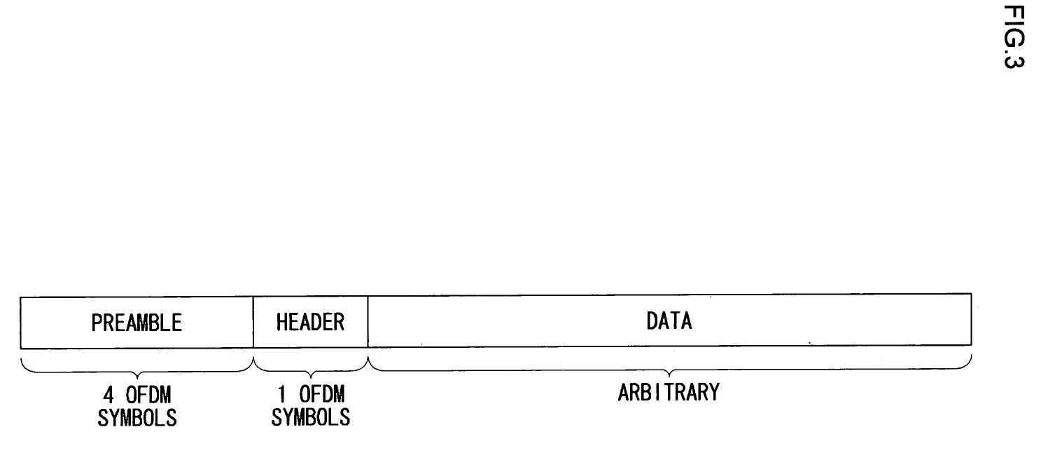

FIG. 3 illustrates a structure of a burst format according to an embodiment of the present invention. This is the burst format used in the traffic channel of IEEE802.11a standard which is one of wireless LANs (Local Area Networks). The IEEE802.11a standard uses the OFDM modulation scheme. In the OFDM modulation scheme, the total of Fourier transform size and the number of symbols in guard interval is defined as a unit. In the present embodiment, this single unit is called “OFDM symbol”. In the IEEE802.11 standard, the size of Fourier transform is 64 (hereinafter, one FFT point will be called “FFT point”). Thus, since the number of FFT points for a guard interval is 16, an OFDM symbol is equivalent to 80 FFT points.

A preamble which is to be used mainly for timing synchronization and channel estimation is placed in the four leading OFDM symbols of a burst. The preamble signal is equivalent to a known signal. Thus, the signal processing unit 18 can use a preamble as a training signal described later. “Header” and “data” that follow the “preamble” are not the known signal but are equivalent to data signals. In the IEEE802.11a standard, known pilot signals are contained in the subcarrier numbers “−21”, “−7”, “7” and “21” even in the data signals period.

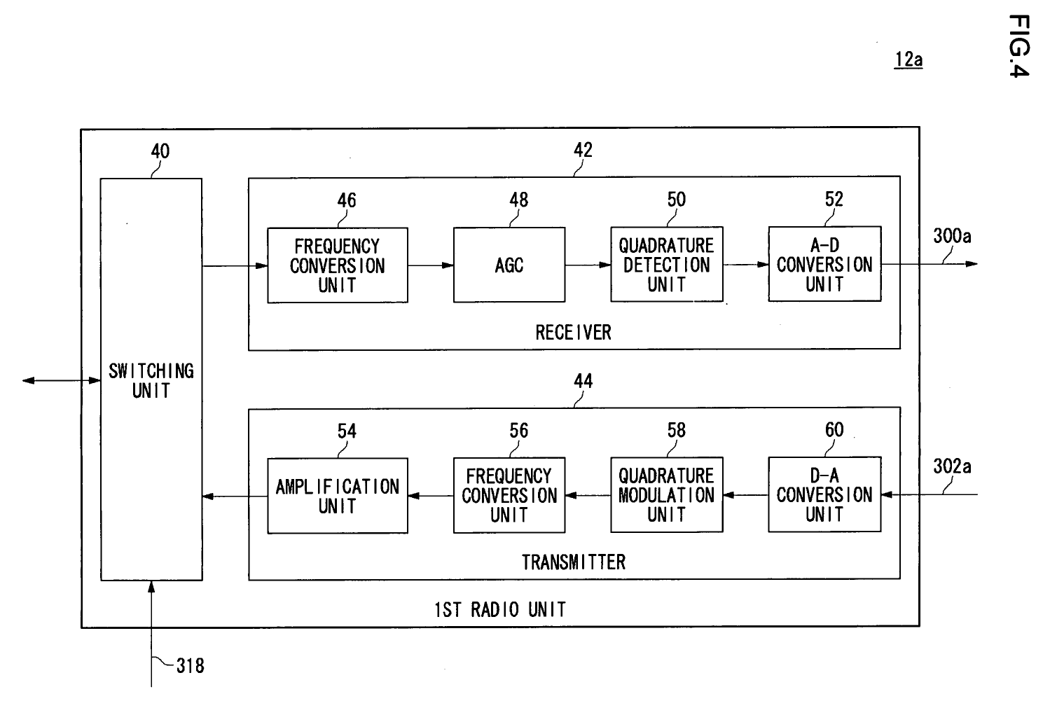

FIG. 4 illustrates a structure of a first radio unit 12a. The first radio unit 12a includes a switching unit 40, a receiver 42 and a transmitter 44. The receiver 42 includes a frequency conversion unit 46, an AGC (Automatic Gain Control) unit 48, a quadrature detection unit 50 and an A-D conversion unit 52. The transmitter 44 includes an amplification unit 54, a frequency conversion unit 56, a quadrature modulation unit 58 and a D-A conversion unit 60.

The switching unit 40 switches input and output of signals to the receiver 42 and the transmitter 44 according to radio-unit control signals 318 from the control unit 24, which is not shown in FIG. 4. That is, the switching unit 40 selects the signals from the transmitter 44 at the time of transmission whereas it selects the signals to the receiver 42 at the time of receiving. The frequency conversion unit 46 in the receiver 42 and the frequency conversion unit 56 in the transmitter 44 perform frequency conversion on targeted signals between radiofrequencies and intermediate frequencies.

The AGC unit 48 amplifies a received signal by so controlling gain automatically as to make the amplitude of the received signal an amplitude which is within the dynamic range of the A-D conversion unit 52. The quadrature detection unit 50 generates baseband analog signals by performing quadrature detection on intermediate-frequency signals. On the other hand, the quadrature modulation unit 58 generates intermediate-frequency signals by performing quadrature modulation on the baseband analog signals. The A-D conversion unit 52 converts baseband analog signals to digital signals whereas the D-A conversion unit 60 converts baseband digital signals to analog signals. The amplification unit 54 amplifies radiofrequency signals to be transmitted.

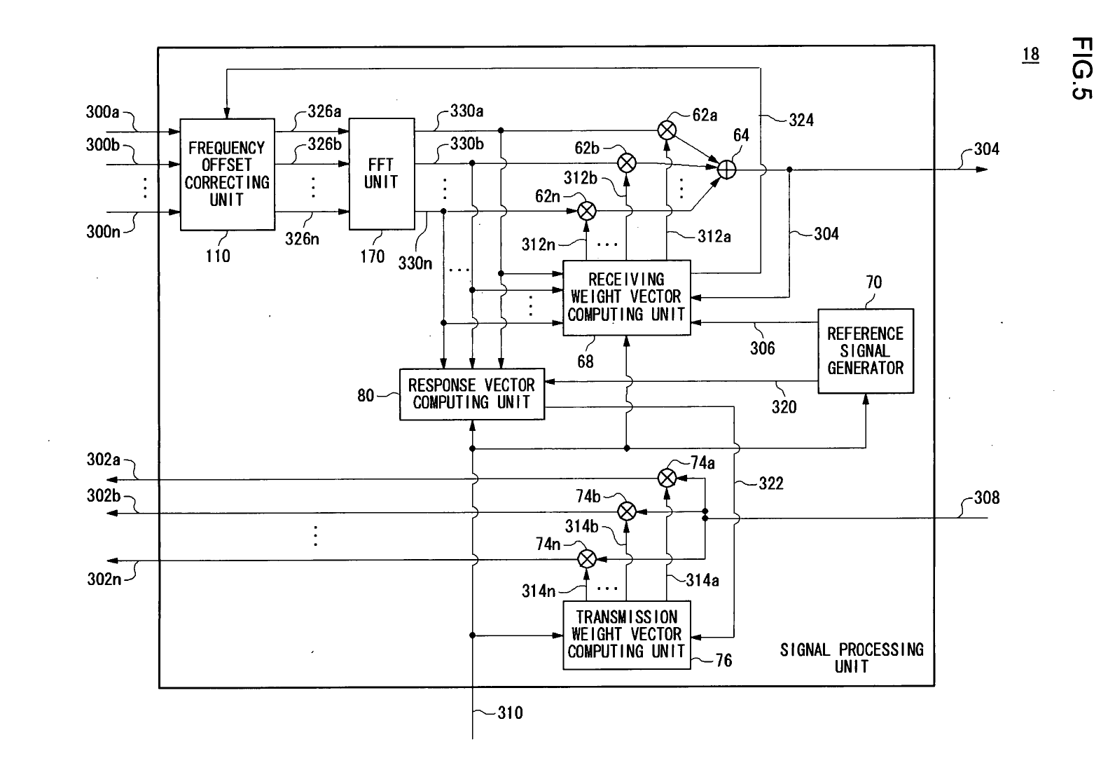

FIG. 5 illustrates a structure of a signal processing unit 18. The signal processing unit 18 includes a frequency offset correcting unit 110, an FFT unit 170, a first multiplier 62a, a second multiplier 62b, . . . and an Nth multiplier 62n, which are generically called “multiplier 62”, an adder 64, a receiving weight vector computing unit 68, a reference signal generator 70, a first multiplier 74a, a second multiplier 74b, . . . and an Nth multiplier 74n, which are generically called “multiplier 74”, a transmission weight vector computing unit 76 and a response vector computing unit 80. Signals involved in the signal processing unit 18 include a weight reference signal 306, a first receiving weight vector signal 312a, a second receiving weight vector signal 312b, . . . and an Nth receiving weight vector signal 312n, which are generically called “receiving weight vector signal 312”, a first transmission weight vector signal 314a, a second transmission weight vector signal 314b, . . . and an Nth transmission weight vector signal 314n, which are generically called “transmission weight vector signal 314”, a response reference signal 320, a response vector signal 322, a residual frequency signal 324, a first corrected received signal 326a, a second corrected received signal 326b, . . . and an Nth corrected received signal 326n, which are generically called “corrected received signal 326”, and first frequency-domain signal 330a, a second frequency-domain signal 330b, . . . and an Nth frequency-domain signal 330n, which are generically called “frequency-domain signal 330”.

The frequency offset correcting unit 110 inputs the digital received signals 300 corresponding respectively to a plurality of basestation antennas 14 not shown here. The digital received signal 300 is known in the preamble period, and it contains pilot signals in the data signal period. The frequency offset correcting unit 110 corrects frequency offsets contained respectively in the digital received signals 300 and then outputs those signals as corrected received signals 326. Though details will be described later, the frequency offset correcting unit 110 first estimates frequency offsets (hereinafter referred to as “initial frequency offsets”), and corrects the digital received signals 300 with the thus estimated initial frequency offsets. Then the frequency offset correcting unit 110 also corrects the frequency offsets by reflecting residual components of the frequency offsets. The residual components of the frequency offsets includes frequency offset that still remains to exist even after the initial frequency offsets have been corrected. In this case, a residual frequency signal 324 is used.

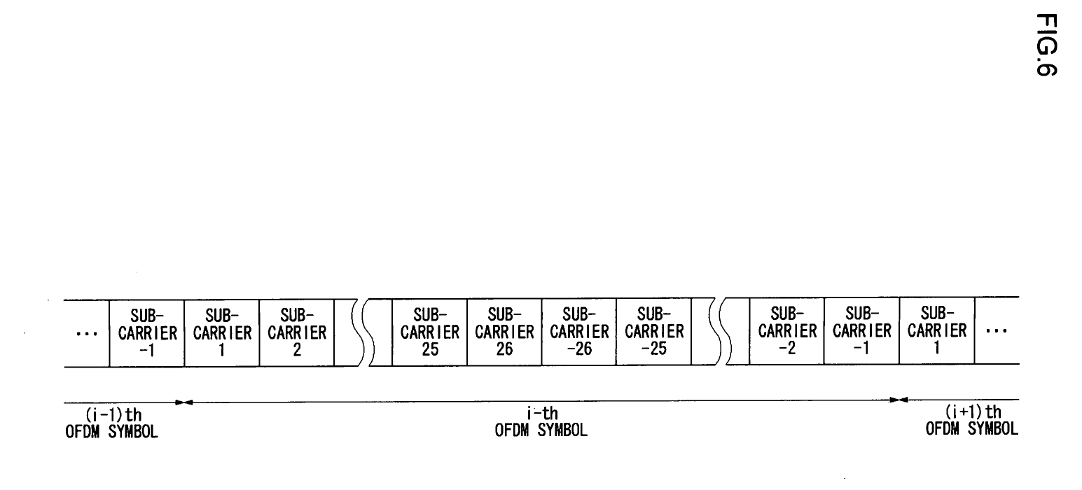

The FFT unit 170 performs Fourier transform on the corrected received signals 326 so as to output the frequency-domain signals 330. That is, the FFT unit 170 transforms the corrected received signals 326 respectively into frequency domains. It is assumed here that signals corresponding to a plurality of subcarriers are arranged serially in each frequency-domain signal 330 (in the first frequency-domain signal 330a, for example). FIG. 6 illustrates a structure of the first frequency-domain signal 330a, as a frequency-domain signal. Assume herein that the “i”-th OFDM symbol is such that subcarriers are arranged in the order of the subcarrier numbers “1” to “26” and the subcarrier numbers “−26” to “−1”. Assume also that an “(i−1)“th OFDM symbol is placed before the “i”-th OFDM symbol, and an “(i+1)”th OFDM symbol is placed after the “i”th OFDM symbol.

Refer back to FIG. 5. Using LMS algorithm, the receiving weight vector computing unit 68 computes receiving weight vector signals 312 from the frequency-domain signals 330, synthesized signal 304 and weight reference signal 306. Here, the receiving weight vector signals 312 are so derived as to correspond respectively to a plurality of basestation antennas 14 and correspond respectively to a plurality of subcarriers in the frequency domain. Here, if the number of antennas is denoted by N and the number of subcarriers by M, the LMS algorithm will be expressed by the following Equation (4).
Wₘ(t+1)=Wₘ(t)+μXₘ(t)e(t*)
e(t)=d(t)−Wₘ^{H}(t)Xₘ(t) (4)
where Wₘ(t) is a receiving response vector corresponding to a subcarrier m at time t, and the number of its components is the number N of antennas. As above, the LMS algorithm is performed on a subcarrier-by-subcarrier basis. It is assumed here that the receiving weight vector signal 312 is estimated during a preamble period and will be fixed after the preamble period is terminated. The receiving weight vector 312 like this corresponds also to pilot signals and those other than the pilot signals, in a data-signal period.

Even after the preamble period has been terminated, the receiving weight vector computing unit 68 extracts pilot signals assigned in a plurality of subcarriers from among the frequency-domain signals 330, and derives receiving weight vector signals 312 corresponding to the pilot signals and error between them and the pilot signals by applying the LMS algorithm to the pilot signals. Here, the LMS algorithm is applied to mutually corresponding pilot signals among a plurality of frequency-domain signals. For example, the LMS algorithm is applied to a component corresponding to the subcarrier number “−21” in a plurality of frequency-domain signals 330. As a result of the above, the receiving weight vector computing unit 68 derives error for the number of pilot signals, namely, “4”.

Based on the receiving weight vector signal and the error, the receiving weight vector computing unit 68 estimates residual components of frequency offset contained in the pilot signals among the frequency-domain signals 330. That is, the receiving weight vector computing unit 68 multiplies the complex conjugation of the frequency-domain signals 330 corresponding to the pilot signals by the errors, respectively, and then extracts imaginary components from the result of division by the receiving weight vector signals 312 corresponding to the pilot signals. Here, “corresponding to the pilot signals” may also be equivalent to “corresponding to the subcarriers to which the pilot signals are assigned. With the above processing, the residual components of frequency offset corresponding respectively to the pilot signals are estimated.

Furthermore, the receiving weight vector computing unit 68 performs statistical processing, such as averaging processing, on the residual components of frequency offset corresponding respectively to the pilot signals so as to derive the residual components of frequency offset. The receiving weight vector computing unit 68 outputs the thus derived residual components of frequency offset as residual frequency signals 324. The residual components of frequency offset are estimated as values in a period when the corrected received signals 326 are to be converted to the frequency domain, namely, in the period of “one OFDM symbol”.

The multiplier 62 weights the frequency-domain signal 330 with the receiving weight vector signal 312, and the adder 64 adds up the outputs of the multipliers 62 and then outputs a combined signal 304. Since, as described above, the frequency-domain signal 330s are arranged in the order of subcarrier numbers here, the receiving weight vector signals 312 are also arranged correspondingly thereto. That is, each multiplier 62 inputs successively the receiving weight vector signals 312 arranged in the order of the subcarrier numbers. Hence, the adder 64 adds up the multiplication result on a subcarrier-by-subcarrier basis. As a result, the combined signals 304 are also arranged serially, as shown in FIG. 6, in the order of the subcarrier numbers.

In the following description, too, if the signals to be processed are defined in the frequency domain, the processing will be carried out basically on a subcarrier-by-subcarrier basis. For the brevity of description, the processing of a single subcarrier will be explained here. Thus, to achieve the processing of a plurality of subcarriers, the processing for a single subcarrier is carried out in parallel or serially.

During a training period, the reference signal generator 70 outputs training signals stored beforehand, as the weight reference signals 306 and response reference signals 320. After the training period, the pilot signals stored beforehand are outputted as the weight reference signals 306.

The response vector computing unit 80 computes response vector signals 322 as receiving response characteristics of the received signals against the transmitted signals, from the frequency-domain signals 330 and the response reference signals 320. A method for computing the response vector signals 322 may be arbitrary, but it may be performed as follows based on correlation processing, for example. It is assumed herein that the frequency-domain signals 330 and the response reference signals 320 are inputted not only from within the signal processing unit 18 but also from signal processing units corresponding to other signals to be processed via signal lines, which are not shown here. As described earlier, the following description will be given focusing on one of a plurality of subcarriers. If a frequency-domain signal 330 corresponding to a first processing object is designated as x₁(t), a frequency-domain signal 330 corresponding to a second processing object as x₂(t), a response reference signal 320 corresponding to the first processing object as S₁(t) and a response reference signal 320 corresponding to the second processing object as S₂(t), then x₁(t) and x₂(t) will be expressed by the following Equation (5):
x₁(t)=h₁₁S₁(t)+h₂₁S₂(t)
x₂(t)=h₁₂S₁(t)+h₂₂S₂(t) (5)
where hᵢⱼ is the response characteristic from an i-th terminal apparatus to a j-th basestation antenna 14j, with noise ignored. A first correlation matrix R₁, with E as an ensemble average, is expressed by the following Equation (6):

$${R}_{1} = [ \begin{matrix}E [ {x}_{1} {S}_{1}^{*} ] & E [ {x}_{1} {S}_{2}^{*} ] \\ E [ {x}_{2} {S}_{1}^{*} ] & E [ {x}_{2} {S}_{2}^{*} ]\end{matrix} ] \qquad ( 6 )$$

A second correlation matrix R₂ among the response reference signals 320 is computed by the following Equation (7):

$${R}_{2} = [ \begin{matrix}E [ {S}_{1} {S}_{1}^{*} ] & E [ {S}_{1} {S}_{2}^{*} ] \\ E [ {S}_{2} {S}_{1}^{*} ] & E [ {S}_{2} {S}_{2}^{*} ]\end{matrix} ] \qquad ( 7 )$$

Finally, the first correlation matrix R₁ is multiplied by the inverse matrix of the second correlation matrix R₂ so as to obtain a response vector signal 322, which is expressed by the following Equation (8):

$$[ \begin{matrix}{h}_{11} & {h}_{12} \\ {h}_{21} & {h}_{22}\end{matrix} ] = {R}_{1} {R}_{2}^{- 1} \qquad ( 8 )$$

The transmission weight vector computing unit 76 estimates the transmission weight vector signal 314 necessary for weighting the pre-separation signal 308, from the receiving weight vector signal 312 or the response vector signal 322 serving as receiving response characteristics. The method for estimating the transmission weight vector signals 314 may be arbitrary. As a most simple method therefor, however, the receiving weight vector signals 312 may be used intact. Alternatively, the receiving weight vector signal 312 or the response vector signal 322 may be corrected using a conventional technique while the Doppler frequency variation of a propagation environment caused by a timing difference between a receiving processing and a transmission processing is taken into account.

The multipliers 74 weight the pre-separation signal 308 with the transmission weight vector signals 314, respectively, and then output the thus weighted transmission weight vector signals 314 as the digital transmitted signals 302. It is assumed herein that the timing in the above operation is instructed by the signal processor control signal 310.

In terms of hardware, the above-described structure can be realized by a CPU, a memory and other LSIs of an arbitrary computer. In terms of software, it is realized by memory-loaded programs which have a reserved management function or the like, but drawn and described herein are function blocks that are realized in cooperation with those. Thus, it is understood by those skilled in the art that these function blocks can be realized in a variety of forms such as by hardware only, software only or the combination thereof.

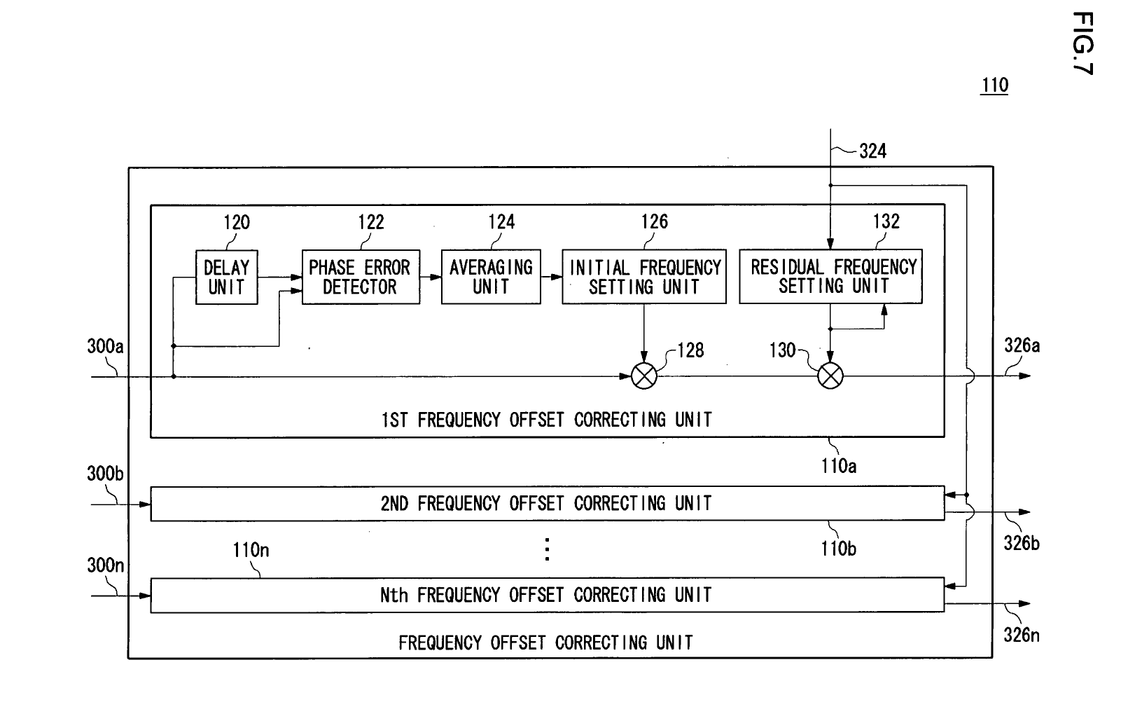

FIG. 7 illustrates a structure of a frequency offset correcting unit 110. The frequency offset correcting unit 110 is a generic name given for a first frequency offset correcting unit 110a, a second frequency offset correcting unit 110b, . . . and an Nth frequency offset correcting unit 110n. Each of the frequency offset correcting units 110a to 110n includes a delay unit 120, a phase error detector 122, an averaging unit 124, an initial frequency setting unit 126, a multiplier 128, a multiplier 130 and a residual frequency setting unit 132.

The delay unit 120 delays the inputted digital received signals 300. Here, the delay unit 120 delays them by one OFDM symbol. The phase error detector 122 detects phase error between the digital received signal 300 delayed by the delay unit 120 and the inputted digital received signal 300. This phase error corresponds to a rotation amount of phase in one OFDM symbol due to the frequency offset. If the digital received signals 300 contain signal components, the signal components are removed. The averaging unit 124 averages out the phase error detected by the phase error detector 122, for the purpose of suppressing noise components. The initial frequency setting unit 126 sets the phase error averaged by the averaging unit 124 as a phase error corresponding to the initial frequency offset, and outputs signals to be oscillated based on the initial frequency offset. The multiplier 128 multiplies the signals to be oscillated by the initial frequency offset outputted from the initial frequency setting unit 126, by the inputted digital received signals 300 and then removes from the inputted digital received signals 300 the phase error corresponding to the initial frequency offset.

The residual frequency setting unit 132 sets the residual frequency offsets by successively updating them with the residual frequency signals 324 which have been inputted externally, and outputs signals which are oscillated based on the most recently updated residual frequency offsets. Here, since the residual frequency signals 324 are inputted after a training signal period has been terminated, the signals which are oscillated based on the residual frequency offsets are outputted after the training signal period has been terminated. The multiplier 130 multiplies output signals from the multiplier 128 by outputs signals from the residual frequency setting unit 132 so as to remove the residual frequency offsets contained in the output signals from the multiplier 128, and it outputs the resulting signals as corrected received signals 326.

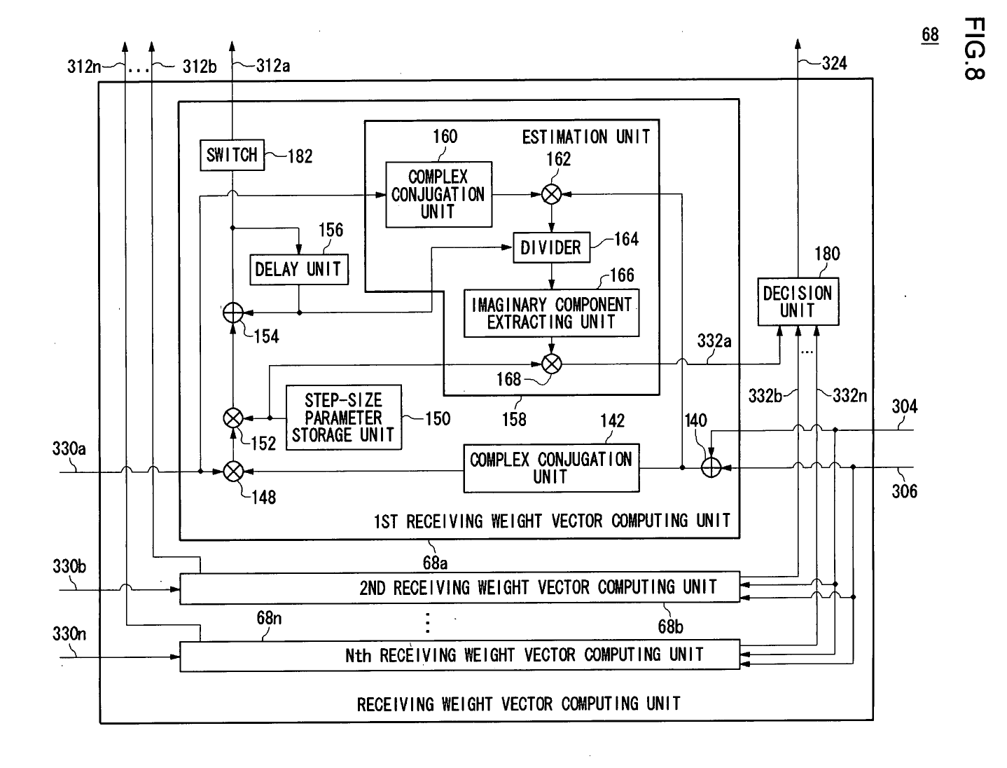

FIG. 8 illustrates a structure of a receiving weight vector computing unit 68. The receiving weight vector computing unit 68 is a generical name given for a first receiving weight vector computing unit 68a, a second receiving weight vector computing unit 68b, . . . and an Nth receiving weight vector computing unit 68n, and includes a decision unit 180. Each of the receiving weight vector computing units 68a to 68n includes an adder 140, a complex conjugation unit 142, a multiplier 148, a step-size parameter storage unit 150, a multiplier 152, an adder 154, a delay unit 156, an estimation unit 158 and a switch 182. The estimation unit 158 includes a complex conjugation unit 160, a multiplier 162, a divider 164, an imaginary component extracting unit 166 and a multiplier 168.

The adder 140 computes the difference between the combined signal 304 and the weight reference signal 306, and outputs an error signal. The adder 140 derives error signals between the combined signals 304 and the weight reference signals 306 corresponding to all the subcarriers. After the end of a preamble, the adder 140 derives an error signal between a combined signal 304 and a weight reference signal 306 corresponding to a pilot signal. Both the combined signal 304 and the weight reference signal 306 have the format shown in FIG. 6. This error signal is subjected to a complex conjugation conversion by the complex conjugation unit 142.

The multiplier 148 multiplies the complex-conjugation-converted error signal by the first frequency-domain signal 330a so as to generate a first multiplication result. The multiplier 152 multiplies the first multiplication result by a step-size parameter stored in the step-size parameter storage unit 150 so as to generate a second multiplication result. The second multiplication result is subjected to a feedback by the delay unit 156 and the adder 154. Thereafter, the second multiplication result is added with a new second multiplication result. In this manner, the result of addition updated successively by the LMS algorithm is outputted as a receiving weight vector 312. Though the above processing is performed on all the subcarriers over a preamble period, it is performed on the pilot signals after the end of a preamble. The switch 182 fixes the values of receiving weight vector signals 312 at the time the preamble ends.

The estimation unit 158 estimates residual components of frequency offsets. Before describing each component of the estimation unit 158, an overall operation of an estimation unit 158 will be outlined. For the clarity of explanation, how to estimate a residual component of frequency offset for a single pilot signal will be explained. It is assumed herein that a receiving weight vector 312 at time t is designated as W(t) Also, a phase corresponding to the residual frequency offset contained in the frequency-domain signal 330 is denoted by φ. Then, a receiving weight vector W(t+1) at time t+1 is expressed by the following Equation (9):
W(t+1)=W(t)exp(jφ) (9)

If error between the receiving weight vectors W(t+1) and W(t) is Δ, a relationship between the receiving weight vectors W(t+1) and W(t) is expressed by the following Equation (10):
W(t+1)=W(t)+Δ (10)

Combining or equating the above Equation (9) and Equation (10) results in:
W(t)exp(jφ)=W(t)+Δ(11)

If the phase φ is small, the Equation (11) is expressed by:
W(t)·jφ=Δ (12)

Hence, the phase φ is expressed by:

$$ϕ = Img ( \frac{Δ}{W ( t )} ) \qquad ( 13 )$$

where “Img” indicates the imaginary component. If the Equation (13) is associated with a recurrence formula of LMS algorithm, the error will be expressed by:
Δ=μ·X*(t)·e(t) (14)
where μ is a step-size parameter in the LMS algorithm, X is a vector that corresponds to a frequency-domain signal 330, and e is a vector that corresponds to an error signal in the LMS algorithm. Hence, the phase φ to be estimated is expressed by:

$$ϕ = Img ( \frac{μ {X}^{*} ( t ) e ( t )}{W ( t )} ) = μ Img ( \frac{{X}^{*} ( t ) e ( t )}{W ( t )} ) \qquad ( 15 )$$

As described above, since four pilot signals are inserted, the phase φ estimated for a single pilot signal has undergone the statistical processing and then a phase corresponding to one basestation antenna 14 is derived. If the statistical processing is averaging, a phase to be derived is expressed by the following Equation (16).

$$ϕ = \frac{μ}{4} Img {\sum }_{m = 1}^{4} ( \frac{{X}_{m}^{*} ( t ) {e}_{m} ( t )}{{W}_{m} ( t )} ) \qquad ( 16 )$$

In Equation (16), the phase to be derived is also denoted by φ. In other words, the estimation unit 158 is so structured as to compute the Equation (16). Furthermore, phases which have been derived respectively for a plurality of basestation antennas 14 may be averaged.

The complex conjugation unit 160 performs complex conjugation conversion on frequency-domain signals 330. The multiplier 162 multiplies the complex-conjugation-converted frequency-domain signal 330 by the error signal outputted from the adder 140. The divider 164 divides a multiplication result obtained by the multiplier 162, by a receiving weight vector signal 312 outputted from the delay unit 156. The imaginary component extracting unit 166 extracts imaginary components from a division result. The multiplier 168 multiplies the imaginary components in the division result by a step-size parameter so as to generate residual-component signals 332. Each residual-component signal 332 corresponds to each basestation antenna 14 described above and also corresponds to a phase corresponding to each pilot signal.

The decision unit 180 inputs a plurality of residual-component signals 332 and then derives one phase by performing statistical processing on these residual-component signals 332. Then the decision unit 180 outputs one phase as a residual frequency signal 324. Here, the decision unit 180 performs averaging as the statistical processing, as described above. By such a processing as this, the phase is derived where all the basestation antennas 14 are taken into consideration and all the pilot signals are also taken into account. It is to be noted that the residual frequency signal 324 is outputted after the completion of a preamble period.

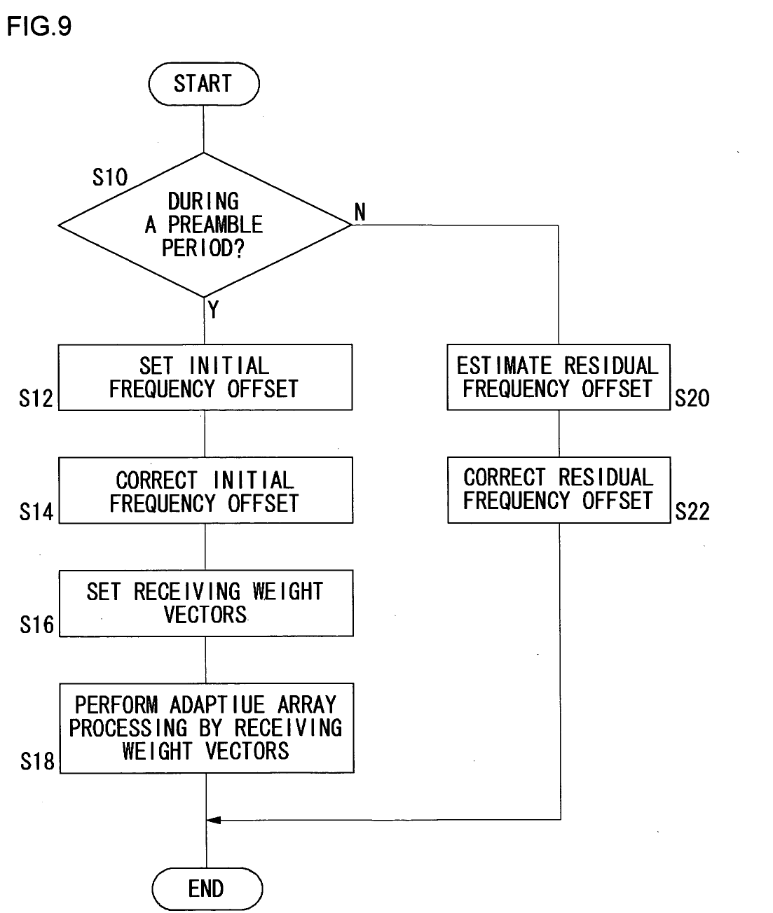

FIG. 9 is a flowchart showing a procedure of correcting frequency offsets. During a preamble period (Y of S10), the delay unit 120, phase error detector 122 and averaging unit 124 estimate initial frequency offsets (S12). When the estimation has been completed, the initial frequency setting unit 126 sets the estimated initial frequency offsets and the multiplier 128 corrects the initial frequency offsets contained in the digital received signals 300 (S14). Then the receiving weight vector computing unit 68 estimates receiving weight vectors (S16), and the multiplier 62 and the adder 64 perform adaptive array processing by the receiving weight vectors (S18).

When the preamble period terminates (N of S10), the receiving weight vector computing unit 68 estimates a residual component of frequency offset from the frequency-domain signal 330, and outputs this as a residual frequency signal 324 (S20). Then the residual frequency signal 324 is fed back to the residual frequency setting unit 132, and the multiplier 130 corrects the residual component of frequency offset (S22). Based on the receiving weight vector signal 312, the multiplier 62 and the adder 64 performs adaptive array processing on the frequency-domain signal 330. Even after the preamble has terminated, the initial frequency offset continues to be corrected.

An operation of the base station apparatus 34 that employs the above structure will be described hereinbelow. During a preamble period of received burst, the delay unit 120, phase error detector 122 and the averaging unit 124 estimate initial frequency offsets contained in digital received signals 300. During a training signal period, the output signals from the multiplier 128 are outputted as the corrected received signals 326. The FFT unit 170 converts the corrected received signals 326 into the frequency domain, and then outputs the frequency-domain signals 330. The frequency-domain signals 330 are inputted to the receiving weight vector computing unit 68, and the receiving weight vector computing unit 68 estimates the receiving weight vector signals 312.

After the training signal period has terminated, the multiplier 130 corrects the signal outputted from the multiplier 128, by an residual frequency error based on the residual frequency signal 324, and outputs the thus corrected signal as the corrected received signal 326. The FFT unit 170 converts the corrected received signal 326 into the frequency domain, and outputs the frequency-domain signal 330. The receiving weight vector computing unit 68 estimates the residual frequency signal 324. The residual frequency signal 324 is fed back to the residual frequency setting unit 132. After the frequency-domain signals 330 are each weighted with the receiving weight vector signals 312 at the multiplier 62, they are summed up by the adder 64.

According to the embodiments of the present invention, weighting factors and error derived in adaptive algorithms are used in estimating the residual components of frequency offset. Hence, the estimation processing for residual components and part of the adaptive algorithms can be put to a common use. Since part of processings can be shared, the increase in circuit scale can be prevented. Since the frequency offsets can be corrected, the transmission quality can be improved. Since pilot signals are used as a reference necessary for estimating the frequency offset, the error of a reference signal in the estimation of frequency offsets can be prevented. Since a pilot signal serves as a reference, the decision processing for a combined signal can be eliminated. Since the decision processing for a combined signal can be eliminated, the delay period in the estimation of frequency offsets can be shortened. The residual components of frequency offsets can be estimated by a simplified processing. Since adaptive array processing is carried out while being weighted with weight vectors, the transmission quality can be improved. The present embodiments can be applied to multicarrier signals, too. Since the residual components of frequency offsets are derived using the residual components that correspond to a plurality of pilot signals, the derivation accuracy can be improved.

The initial frequency offsets are corrected by the feedforward prior to computing the receiving weight vectors, and the residual components of frequency offsets are corrected. Thus, even if the frequency offset is large, it can be corrected. Step-size parameters necessary for obtaining the receiving weight vectors in adaptive algorithms can be set to a certain small value even if a frequency offset is present. Hence, the deterioration of signals due to nose can be prevented. Moreover, values computed in a process of adaptive algorithm can be used in computing the residual components of frequency offsets, so that the increase in circuit scale can be prevented.

The present invention has been described based on the embodiments which are only exemplary. It is therefore understood by those skilled in the art that other various modifications to the combination of each component and process are possible and that such modifications are also within the scope of the present invention.

According to the present embodiments of the present invention, the receiving weight vector computing unit 68 uses the LMS algorithm as an adaptive algorithm by which to estimate the receiving weight vector signals 312. However, an adaptive algorithm other than the LMS algorithm may be used in the receiving weight vector computing unit 68. For example, the RLS algorithm may be used instead. According to this modification, the receiving weight vector signals 312 converge faster. That is, it suffices if receiving weight vectors and error signals necessary for estimating residual frequency offsets are generated.

According to the present embodiments of the present invention, the delay unit 120 delays the digital received signal 300 by one symbol to estimate the initial frequency offset. However, the present invention is not limited thereto and, for example, the digital received signal 300 may be delayed by a plurality of symbols. According to this modification, the accuracy of detecting the frequency offset can be improved. That is, the number of symbols to be delayed may be set in accordance with a value to be expected as a residual component of frequency offset.

In the present embodiment, the communication system 100 transmits multicarrier signals, and it is assumed that pilot signals are inserted in part of the multicarirer signals. However, the arrangement is not limited thereto and, for example, the communication system 100 may transmit single-carrier signals and the pilot signals may be inserted in a partial period of single-carrier signals. In other words, the pilot signals may be inserted discretely and periodically. In such a case, the residual components of frequency offsets are estimated at discrete timings. The communication system 100 may be a MIMO (Multiple-Input Multiple-Output) system. In such a case, the terminal apparatus 10 has a plurality of terminal antennas 16 and transmits signals corresponding respectively to the plurality of terminal antennas 16. Then the base station apparatus 34 has a plurality of signal processing units 18 and a plurality of modem units 29 for signals corresponding respectively to the plurality of terminal antennas 16. According to this modification, the present invention can be applied to various types of communication systems 100. That is, it suffices if the pilot signals are used as a reference with which to estimate the residual components of frequency offset.

In the present embodiment, the decision unit 180 performs averaging processing to derive one residual frequency signal 324 from a plurality of residual component signals 332. However, the arrangement is not limited thereto and, for example, the decision unit 180 may perform a statistical processing, such as taking a median value, other than the averaging. Also, the decision unit 180 may simply select one from among a plurality of residual component signals 332 and may take this selected signal as the residual frequency signal 324. According to this modification, the residual frequency signal 324 can be determined by employing a variety of methods. That is, it suffices as long as a single residual frequency signal 324 can be determined.

While the preferred embodiments of the present invention have been described using specific terms, such description is for illustrative purposes only, and it is to be understood that changes and variations may be made without departing from the spirit or scope of the appended claims.

What is claimed is:

1. A frequency offset correcting apparatus, comprising:
an input unit which inputs a plurality of received signals, corresponding respectively to a plurality of antennas, that contain known signals;
a correction unit which corrects respectively frequency offsets contained in the plurality of received signals;
a processing unit which derives weight vectors corresponding to the known signals and error between the weight vectors and the known signals, respectively, by applying an adaptive algorithm to the plurality of corrected received signals; and
an estimation unit which estimates residual components of the frequency offsets contained in the plurality of corrected received signals and those of frequency offsets corresponding to the known signals, based on the derived weight vectors and the derived error,
wherein said correction unit corrects the frequency offsets by reflecting the estimated residual components of frequency offsets.

2. A frequency offset correcting apparatus according to claim 1, wherein as the residual components of frequency offsets said estimation unit multiplies complex conjugation of the plurality of corrected received signals respectively by the derived error and extracts imaginary components from a division result where the multiplication result is divided by the derived weight vectors.

3. A frequency offset correcting apparatus according to claim 1, wherein said processing unit derives weight vectors corresponding to signals other than the known signals,
the apparatus further comprising a weighting unit which weights the plurality of corrected received signals, respectively, with the weight vectors derived by said processing unit.

4. A frequency offset correcting apparatus according to claim 1, further comprising a frequency-domain conversion unit which converts the plurality of corrected received signals, respectively, into frequency domains and outputs a plurality of frequency-domain signals to each corrected received signal,
wherein said processing unit extracts known signal components contained in the plurality of frequency-domain signals and derives the weight vectors and error by applying adaptive algorithm to mutually corresponding known signals, and
wherein said estimation unit estimates the residual components of frequency offset corresponding to the known signals, based on the weight vectors and error.

5. A frequency offset correcting apparatus according to claim 4, wherein said processing unit extracts a plurality of known signals contained in the plurality of frequency-domain signals and derives weight vectors and error corresponding respectively to the plurality of known signals, and
wherein said estimation unit estimates frequency offsets corresponding respectively to the plurality of known signals and derives residual components of frequency offsets to be used by said correction unit, from the estimated frequency offsets corresponding respectively to the plurality of known signals.

6. A frequency offset correcting apparatus according to claim 4, wherein said estimation unit estimates residual components of frequency offsets in a period during which the plurality of corrected received signals are to be converted to the frequency domain.

7. A frequency offset correcting apparatus according to claim 4, wherein said processing unit derives weight vectors corresponding to signals other than the known signals,
the apparatus further comprising a weighting unit which weights the plurality of frequency-domain signals, respectively, with the weight vectors derived by said processing unit.

8. A method for estimating frequency offset, characterized in that weight vectors corresponding to known signals and error between the weight vectors and the known signals are derived, respectively, by applying an adaptive algorithm to a plurality of received signals, corresponding respectively to a plurality of antennas, that contain the known signals, and residual components of the frequency offsets contained in a plurality of corrected received signals and those of frequency offsets corresponding to the known signals are estimated based on the derived weight vectors and error.

9. A method for estimating frequency offset, the method comprising:
inputting a plurality of received signals, corresponding respectively to a plurality of antennas, that contain known signals;
correcting respectively frequency offsets contained in the plurality of received signals;
deriving weight vectors corresponding to the known signals and error between the weight vectors and the known signals, respectively, by applying an adaptive algorithm to a plurality of corrected received signals; and
estimating residual components of the frequency offsets contained in the plurality of corrected received signals and those of frequency offsets corresponding to the known signals, based on the derived weight vectors and the derived error,
wherein said correcting is such that the frequency offsets are corrected by reflecting the estimated residual components of frequency offsets.

10. A method according to claim 9, wherein said estimating is such that, as the residual components of frequency offsets, complex conjugation of the plurality of corrected received signals are multiplied respectively by the derived error and then imaginary components are extracted from a division result where the multiplication result is divided by the derived weight vectors.

11. A method according to claim 9, wherein said deriving is such that weight vectors corresponding to signals other than the known signals are derived, the method further comprising weighting the plurality of corrected received signals, respectively, with the weight vectors derived by said deriving.

12. A method according to claim 9, further comprising converting the plurality of corrected received signals, respectively, into frequency domains and outputting a plurality of frequency-domain signals to each corrected received signal,
wherein said deriving is such that known signal components contained in the plurality of frequency-domain signals are extracted and the weight vectors and error are derived by applying adaptive algorithm to mutually corresponding known signals, and wherein said estimating is such that the residual components of frequency offset corresponding to the known signals are estimated based on the derived weight vectors and error.

13. A method according to claim 12, wherein said deriving is such that a plurality of known signals contained in the plurality of frequency-domain signals are extracted and weight vectors and error corresponding respectively to the plurality of known signals are derived, and
wherein said estimating is such that frequency offsets corresponding respectively to the plurality of known signals are estimated and residual components of frequency offsets to be used in the correcting unit are derived from the estimated frequency offsets corresponding respectively to the plurality of known signals.

14. A method according to claim 12, wherein said estimating is such that residual components of frequency offsets in a period during which the plurality of corrected received signals are to be converted to the frequency domain are estimated.

15. A method according to claim 12, where said deriving is such that weight vectors corresponding to signals other than the known signals are derived,
the method further comprising weighting the plurality of frequency-domain signals, respectively, with the weight vectors derived by said deriving.
